(19) United States
(12) Patent Application Publication
(10) Pub. No.: US 2006/0239637 A1
(43) Pub. Date: Oct. 26, 2006

(54) Projection apparatus

(75) Inventor: Takashi Chosa, Kurume-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: Canon Kabushiki Kaisha, Ohta-ku (JP)

(21) Appl. No.: 11/398,050

(22) Filed: Apr. 4, 2006

(30) Foreign Application Priority Data
Apr. 8, 2005 (JP) 2005-112555

(51) Int. Cl. H04N 5/91

(52) U.S. Cl. 386/46

(57) ABSTRACT

At least one exemplary embodiment is directed to a projection apparatus that can be separated into a projection section and a projection accessory section. The projection section can have a chargeable battery, and the projection accessory section can have a charging unit for charging the battery. The projection section includes a recording medium. A data file recorded on the recording medium is read by a control unit, and an image corresponding to the data file is projected onto a screen by an optical unit. The projection accessory section includes communication connectors, where the projection accessory section can be viewed as an external storage device on an externally connected PC.

### BACKGROUND OF THE INVENTION

1. Field of the Invention

The present invention relates to projection apparatuses, and more particularly, though not exclusively to projection apparatuses that convert image information into actual images and project the images.

2. Description of the Related Art

Recently, projection apparatuses, such as liquid crystal projectors, have been widely used in conferences and sales activities. Portability or downsizing is demanded for such projection apparatuses. Thus, there are conventional liquid crystal projectors with a polarization converting portion that can be downsized.

Other conventional projection apparatuses driven by batteries include a technology for informing the users of a decrease in the remaining battery power in a visible and remotely recognizable manner.

When setting up such a projection apparatus for conferences, the user first connects the projection apparatus to a personal computer (PC). After adjusting the settings of both the PC and the projection apparatus, desired images can be projected on a screen. Accordingly, the setup of the projection apparatus requires more or less time-consuming and troublesome work.

Additionally, when a user prepares the materials for a conference, the PC to be used in the conference and the PC used for preparing the conference materials can differ. In such a case, the user has to copy the conference materials to the PC to be used in the conference beforehand in the course of conference preparation, which is also troublesome work.

Projection apparatuses capable of being used without PCs have been available in the market. However, such projection apparatuses require users to store the information to be projected in their internal storage devices or removable storage devices beforehand. Thus, this operation does not differ from transferring the information to be projected to the PC, which is to be connected to the projection apparatus, in advance.

### SUMMARY OF THE INVENTION

At least one exemplary embodiment is directed to a projection apparatus that can improve portability and ease of setup.

To this end, a projection apparatus according to at least one exemplary embodiment of the present invention includes a projection section which can have a chargeable battery, and a projection accessory section that is separable from the projection section. The projection section includes a recording medium capable of storing a data file, a recording unit capable of recording the data file on the recording medium through a communication interface, an image forming unit configured to read the data file recorded on the recording medium and forming a display image, and an optical unit configured to project the image formed by the image forming unit. The projection accessory section includes a charging unit configured to charge the chargeable battery.

Further features of the present invention will become apparent from the following description of exemplary embodiments and the attached drawings.

### BRIEF DESCRIPTION OF THE DRAWINGS

FIG. 1 is a schematic configuration block diagram of a projection apparatus according to a first exemplary embodiment of the present invention.

FIG. 2 shows a configuration of a projection section 12 when the projection section 12 is used by itself.

FIG. 3 is a flowchart showing a charging operation of a projection apparatus 10.

FIG. 4 is a flowchart showing a communication operation between a projection apparatus 10 and a PC.

FIG. 5 shows a connection example of a LAN including a projection apparatus 10.

FIG. 6 is a flowchart showing a projecting operation of a projection apparatus 10.

FIG. 7 is a schematic configuration block diagram of a projection apparatus according to a second exemplary embodiment of the present invention.

### DESCRIPTION OF THE EMBODIMENTS

The following description of at least one exemplary embodiment is merely illustrative in nature and is in no way intended to limit the invention, its application, or uses.

Processes, techniques, apparatuses, and materials as known by one of ordinary skill in the relevant art may not be discussed in detail but are intended to be part of the enabling description where appropriate, for example certain connector types are discussed (e.g., 10BASE-T/100BASE-T LAN, and USBs), however, other types of connectors can be used as known by one of ordinary skill, additionally units are discussed briefly such as the charging unit. It is intended that any unit, for example the charging unit, as known by one of ordinary skill in the relevant art can be used.

Notice that similar reference numerals and letters refer to similar items in the following figures, and thus once an item is defined in one figure, it may not be discussed for following figures.

Exemplary embodiments will be described in detail with reference to the accompanying drawings.

### First Exemplary Embodiment

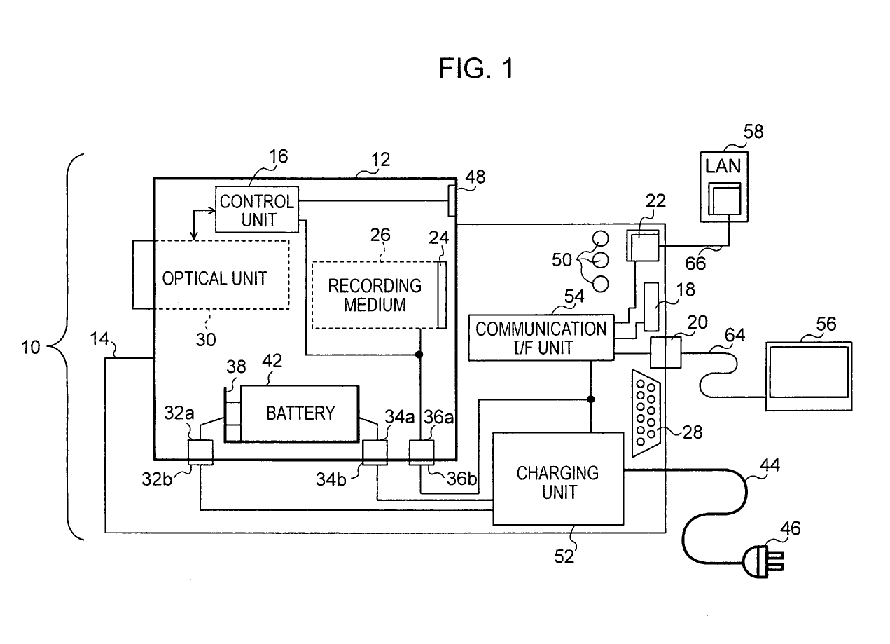

FIG. 1 is a schematic configuration block diagram of a projection apparatus according to a first exemplary embodiment of the present invention. Referring to FIG. 1, a projection apparatus 10 is a projector (e.g., a liquid crystal projector) that converts image information into an actual image and projects the image. In this non limiting example of the first exemplary embodiment, the projection apparatus 10 is the liquid crystal projector, however, the projection apparatus 10 can be a DLP (digital light processing) projector or a projector employing other technologies as known by one of ordinary skill in the relevant arts and equivalents.

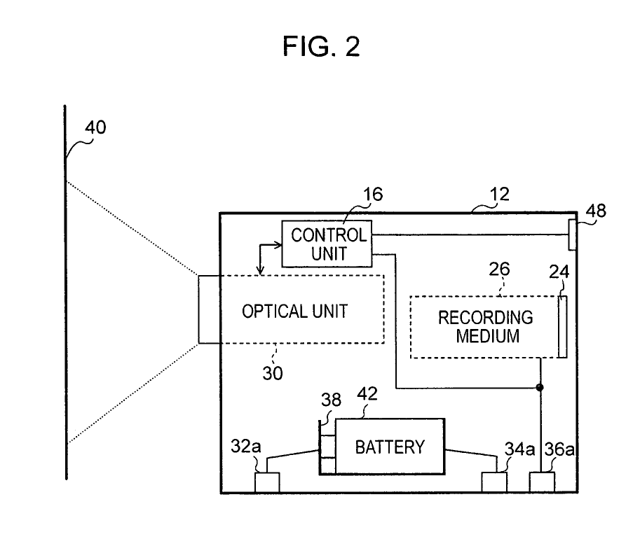

A projection section 12 and a projection accessory section 14 (cradle) of the projection apparatus 10 can be separable. FIG. 1 shows a configuration in which the projection section 12 and the projection accessory section 14 are operatively connected. FIG. 2 shows a configuration of the projection section 12 when the projection section 12 is used by itself. The projection section 12 separated from the projection accessory section 14 is capable of being independently used and carried.

The projection accessory section 14 and the projection section 12 can be operatively connected in the following manner. A positive battery terminal connector 32a, a negative battery terminal connector 34a, and a data connector 36a of the projection section 12 are mechanically and electrically connected to a positive battery terminal connector 32b, a negative battery terminal connector 34b, and a data connector 36b of the projection accessory section 14, respectively. Connecting portions (not shown) can be configured to fit each other.

A control unit 16 performs various controls on the projection section 12. The projection section 12 includes a memory card slot 24 or another recording medium interface. A memory card 26, which is an electrically connected recording medium, is removably inserted into the memory card slot 24. Although the specific example illustrates a memory card slot 24, exemplary embodiments are not limited to a specific interface. Various kinds of recording mediums can be used in exemplary embodiments (e.g., the memory card 26, semiconductor memory, magnetic recording medium, optical recording medium, magneto-optical recording medium, other data storage devices as known by one of ordinary skill in the relevant arts and equivalent). The type of recording medium will determine the type of interface. In the example the memory card slot 24 can include a control circuit, a driving circuit, and/or a connecting circuit in accordance with the recording medium, and these circuits can serve as a recording unit capable of recording a data file on the recording medium, where the data file is received internally or by receiving the data file through a network.

An optical unit 30 includes a projection lens for implementing the projection function, other lenses, mirrors, display panels (e.g., a liquid crystal display panel), and a light source. In the example provided, the optical unit 30 illuminates the liquid crystal panels (not shown) with the light output from the light source. Transmitted light and reflected light from the liquid crystal panels are modulated by the image displayed on the liquid crystal panels. The modulated light is then projected onto a screen 40, whereby an optical image corresponding to the images displayed on the liquid crystal panels is projected onto the screen 40. The optical unit 30 is not limited to specific projection mechanisms, in at least one exemplary embodiment it is capable of projecting the optical images onto the screen 40. Additionally, various kinds of light or other equivalent light apparatus as known by one of ordinary skill in the relevant art can be used as the light source, for example the use of white-light-emitting diodes can be more efficient when considering power consumption.

The projection section 12 is equipped with a battery 42 as a power source. The battery 42 can be any kind of battery. A battery holder 38 holds the battery 42. A positive terminal and a negative terminal of the battery 42 held in the battery holder 38 are connected to the optical unit 30 through the control unit 16 of the projection section 12 with power lines to loads. The positive terminal and the negative terminal of the battery 42 are also connected to the positive battery terminal connector 32a and the negative battery terminal connector 34a, respectively.

A signal line for transferring data and control signals from the memory card slot 24 is connected to the control unit 16 and the data connector 36a.

The projection section 12 also includes an infrared transmitting/receiving unit 48 that converts electric signals to and from infrared signals. The infrared transmitting/receiving unit 48 supplies an electric signal corresponding to a received infrared signal to the control unit 16, and transmits an infrared signal converted from an electric signal supplied from the control unit 16. A user can control the projection section 12 by transmitting an infrared signal to the infrared transmitting/receiving unit 48 using a remote control (not shown).

The projection accessory section 14 is equipped with various connectors. A USB (Universal Serial Bus) type-A connector 18 can be used for connecting a USB device (not shown), (e.g., a mouse, a keyboard), to the projection apparatus 10. A USB type-B connector 20 can be used for connecting a USB host, such as an external PC 56, to the projection apparatus 10. In FIG. 1, the projection apparatus 10, connected to the external PC 56 with a USB cable 64, serves as an external storage device for the external PC 56. With activation of file management software, the user of the external PC 56 can use the projection apparatus 10 as an external storage device. Additionally, the user can read data files stored in the external PC 56 and write the read data in the projection apparatus 10 by operating the USB devices, such as a mouse and a keyboard, connected to the external PC 56.

A 10BASE-T/100BASE-T LAN connector 22 can be connected to a LAN connector 58 of a hub or a communication apparatus with a LAN cable 66. In other words, the projection apparatus 10 can be connected to other external PCs or various network apparatuses through a local area network (LAN).

The USB connector 18, the USB connector 20, and the LAN connector 22 are connected to a communication interface (I/F) unit 54. The communication I/F unit 54 performs protocol conversion in order to deal with the communication signals supplied from each of the connectors 18, 20, and 22, in the projection apparatus 10.

Video signals supplied from PCs or other equivalent apparatus as known by one of ordinary skill in the relevant art are input from a video signal input connector 28, such as a D-sub connector. An audio/video signal input connector 50 can be an analog input connector for video signals and audio signals. The liquid crystal panels included in the optical unit 30 of the projection section 12 are driven by the video input signals, whereby an image corresponding to the video signals from the PC and the other video signals is projected onto the screen 40. The speaker (not shown) is driven by the audio input signal that is supplied to the speaker through an amplifier (not shown), whereby audio is output from the speaker.

The projection accessory section 14 can include a charging unit 52. Alternating current (AC) power is supplied to the charging unit 52 from a commercial AC power line through a plug 46 and an AC wire 44. The charging unit 52 rectifies the AC power to produce stabilized direct-current (DC) power, and supplies the stabilized DC power to each unit. The charging unit 52 includes a charging circuit (not shown) for charging the battery 42 included in the projection section 12. This charging circuit is connected to the positive terminal of the battery 42 through the positive battery terminal connectors 32a and 32b, and to the negative terminal of the battery 42 through the negative battery terminal connectors 34a and 34b.

A communication interface (I/F) unit 54 is connected to the charging unit 52. The communication I/F unit 54 is also connected to the memory card 26, or other recording medium, and the control unit 16, both included in the projection section 12, through the data connectors 36a and 36b.

Insertion of the plug 46 in a plug socket of the commercial AC power line causes the AC power to be supplied to the projection apparatus 10 from the commercial AC power line through the AC wire 44. When a chargeable battery is used, the battery can be charged by the commercial AC power supplied from the plug 46.

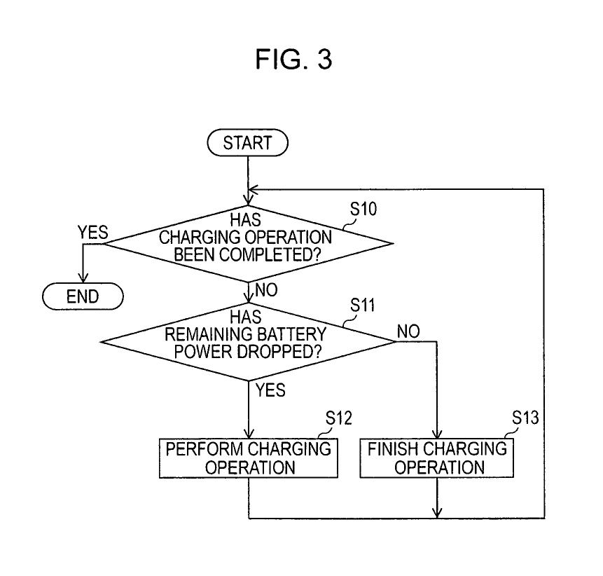

Referring to a flowchart shown in FIG. 3, a charging operation of the projection apparatus 10 according to the first exemplary embodiment will be described. While polling an on/off state of a charging function (at STEP S10), the control unit 16 constantly monitors the remaining battery power of the battery 42 (at STEP S11). When detecting a drop in the remaining battery power of the battery 42 (at STEP S11), the control unit 16 instructs the charging unit 52 to perform the charging operation of the battery 42 (at STEP S12). Upon receiving the instruction, the charging unit 52 charges the battery 42 held in the battery holder 38. When the battery 42 has been charged (at STEP S11), the charging unit 52 finishes the charging operation (at STEP S13). As described above, when the plug 46 is inserted in the plug socket to supply the commercial AC power, the control unit 16 constantly monitors the remaining battery power of the battery 42, and controls the charging unit 52 to make the battery fully charged at all times. The charging unit 52 can be configured to detect the voltage of the battery 42, and control the charging operation of the battery 42. In this case, the control unit 16 is not involved in the charging operation.

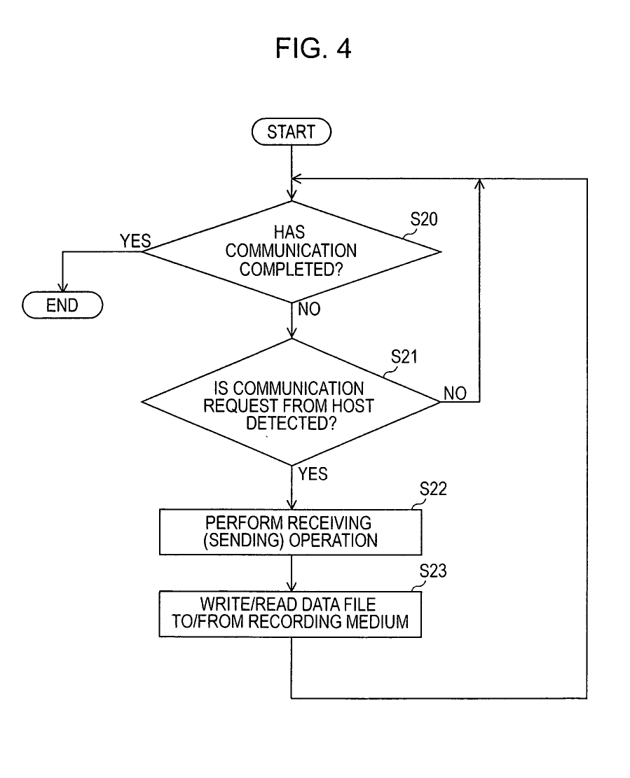

FIG. 4 shows a flowchart of a data writing operation to the projection apparatus 10 from the external PC 56 using a USB connection. In the example shown in FIG. 4, the external PC 56 corresponds to the USB host, and the projection apparatus 10 corresponds to the USB device.

While polling an on/off state of a communication function (at STEP S20), the control unit 16 determines the existence of a communication request sent from the external PC 56 (at STEP S21). If a communication request exists, the control unit 16 communicates with the USB host through the communication I/F unit 54 (e.g., a recording unit) (at STEP S22). A received data file is then written on the recording medium (e.g., memory card 26) included in the projection apparatus 10 according to the instruction of the control unit 16 (at STEP S23).

Likewise, the user can read data from the recording medium (e.g., memory card 26) and transfer the read data to the external PC 56 through the USB connection.

In this way, when viewed from the external PC 56, the projection apparatus 10 can be assumed to be an external storage device.

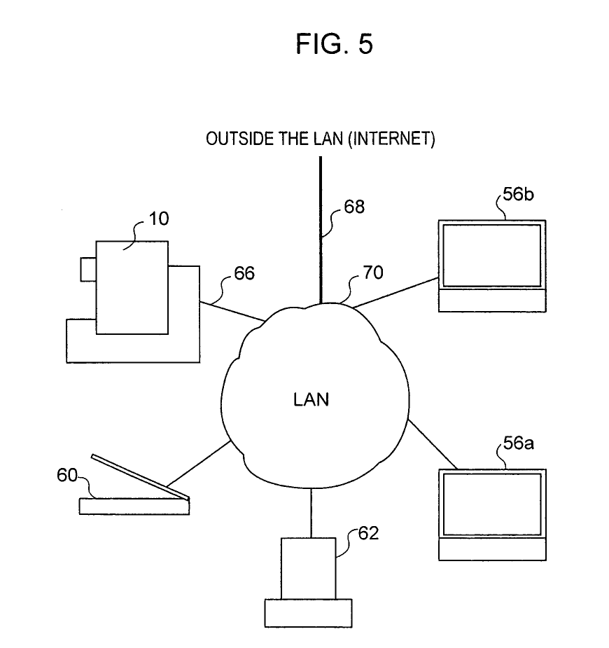

Communication through the LAN provides a further convenience to users. As illustrated in FIG. 5, when the LAN connector 22 (FIG. 1) is connected to the LAN connector 58 (FIG. 1) of a hub with the LAN cable 66, the projection apparatus 10 is connected to the LAN 70. This further allows the projection apparatus 10 to be connected to other external PCs and various network apparatuses through the LAN 70.

Referring to FIG. 5, the LAN 70 is connected to the Internet with a communication cable 68. Note that although the example provided here uses cables to connect items within the LAN, those items (e.g., PCs, projection apparatus) can be connected wirelessly in at least one exemplary embodiment. The projection apparatus 10 is connected to the LAN 70 with the LAN cable 66. A scanner 60, a printer 62, external PCs 56a and 56b are also connected to the LAN 70. The users of the external PCs 56a and 56b are capable of accessing and controlling the projection apparatus 10 through the LAN 70. There is little difference between communications using the LAN connection and the USB connection except for protocol conversion methods. Thus, the user can write and read the data to and from the recording medium (e.g., memory card) 26 included in the projection section 12 using the external PCs 56a and 56b.

Additionally, through the LAN 70, the user can directly input image data scanned by the scanner 60 to the projection apparatus 10, and print file data that is projected by the projection apparatus 10 by sending the file data to the printer 62.

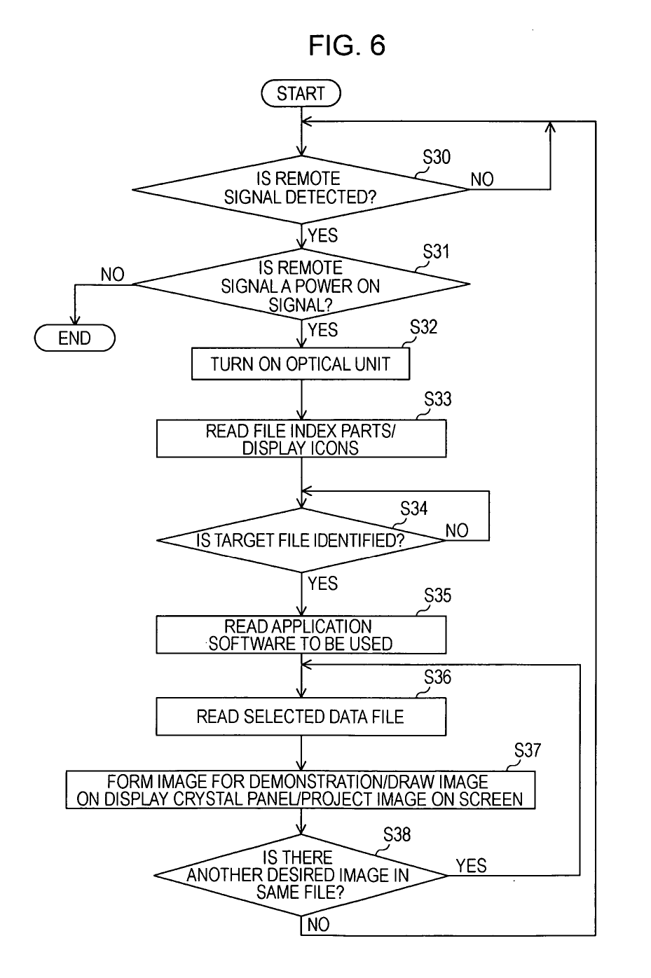

FIG. 6 shows a flowchart showing a projecting operation of the projection apparatus 10 according to the first exemplary embodiment. The user of the projection apparatus 10 transmits a power-on signal to the (e.g., infrared) transmitting/receiving unit 48 using a remote control (not shown). In this example, the infrared transmitting/receiving unit 48 then sends the received remote control signal to the control unit 16. Upon detecting the remote control signal (at STEP S30), the control unit 16 turns on the projection apparatus 10 (at STEP S31).

The control unit 16 then turns on the light source included in the optical unit 30 to illuminate the screen 40 (at STEP S32). The control unit 16 reads index parts of data files (icon images) contained in the memory card 26, and displays the indexes on the display (e.g., in this example liquid crystal) panels included in the optical unit 30 (at STEP S33). This causes the image displayed on the liquid crystal panels included in the optical unit 30 to be projected onto the screen 40.

The user of the projection apparatus 10 can select a desired image contained in a target data file using arrow buttons and a select button provided on the remote control (not shown). The signal corresponding to the user's choice is sent to the control unit 16 through the infrared transmitting/receiving unit 48. The control unit 16 then identifies the target data file (at STEP S34). The control unit 16 determines the attribute of the identified data file to further identify and read a software application used for a demonstration (at STEP S35). The application software, having been stored (e.g., in a read only memory (ROM) and/or a hard disk for storing the applications, or part of the memory card 26), is read to a random access memory (RAM) or other equivalent storage device as known by one of ordinary skill in the relevant art (not shown).

The control unit 16 then reads the image information of the data file, selected from the memory card 26, to the RAM (not shown) (at STEP S36). The image used for the demonstration is formed according to a format of the read out application software, and drawn on the liquid crystal panels included in the optical unit 30 (at STEP S37). This causes the content of the data file to be projected onto the screen 40 from the optical unit 30 according to the format of the suitable application software (at STEP S37).

If the user of the projection apparatus 10 desires to project another image included in the same data file onto the screen 40 (at STEP S38), the user can select the desired image using the arrow buttons and select button of the remote control (at STEPs S36 and S37).

Possible uses of the above-described configuration and operation of the projection apparatus according to the first exemplary embodiment is described below. Suppose the projection apparatus 10 is usually placed on the user's desk or in a space of an office where commonly used office supplies are placed. When the projection apparatus 10 is used by a single user, the projection apparatus 10 is placed on the user's desk, connected to the commercial AC power source through the plug 46, and connected to the user's PC 56 through the USB connection. On the other hand, when the projection apparatus 10 is placed in the commonly used space, the projection apparatus 10 is likewise connected to the commercial AC power source through the plug 46, and to the LAN 70 through the LAN connector 58 of the hub located near the projection apparatus 10.

The user, usually doing paperwork at their desk, prepares the various presentation materials, images, and documents using the external PC 56 placed on their desk. When file management software stored in the external PC 56 is running, the user can use the projection apparatus 10 as a storage device attached to the external PC 56, since the external PC 56 and the projection apparatus 10 are connected through a network. Additionally, use of a mouse and a keyboard permits the user to perform various operations, such as copying, transferring, deleting, reading, and writing, on the various presentation materials, images, and documents created by the user.

The user can deliver a presentation after creating the materials. At this time, the user separates the projection section 12 of the projection apparatus 10 from the projection accessory section 14, and brings the projection section 12 to the place where the presentation is to be delivered, e.g., a projection location. Alternatively, the user can carry the entire projection apparatus 10. With simple operations on a remote control, the user can deliver the presentation using data files that have been completed in the daily work and written on the recording medium (e.g., memory card) 26.

In this example, the preparation process starting with the creation of the presentation materials is described, however, the user can copy the presentation materials to the projection apparatus 10 each time the materials to be used have been completed in the user's daily work. This can reduce the workload for advance preparation of the projection apparatus 10.

The presentation can be delivered without using the PC. More specifically, the work for connecting the PC to the projection apparatus is reduced, therefore making the setup work easier. Also, the user can perform the demonstration with operations on the remote control but without the PC.

The projection section 12 is equivalently light and easy-to-carry, since the projection section 12 and the projection accessory section 14 are configured to be separable. By continuously putting the projection apparatus 10 in the state of usual setting, the battery 42 can be fully charged. This allows the user to perform the demonstration without concern about the remaining battery power of the battery 42, when using the projection apparatus 10.

The projection apparatus 10 includes a recording medium, and it is also possible to write data on the recording medium through the network. This advantageously gives the user improved portability and ease of setup, easier data input and data storing operations using the PC, and a smooth charging operation.

### Second Exemplary Embodiment

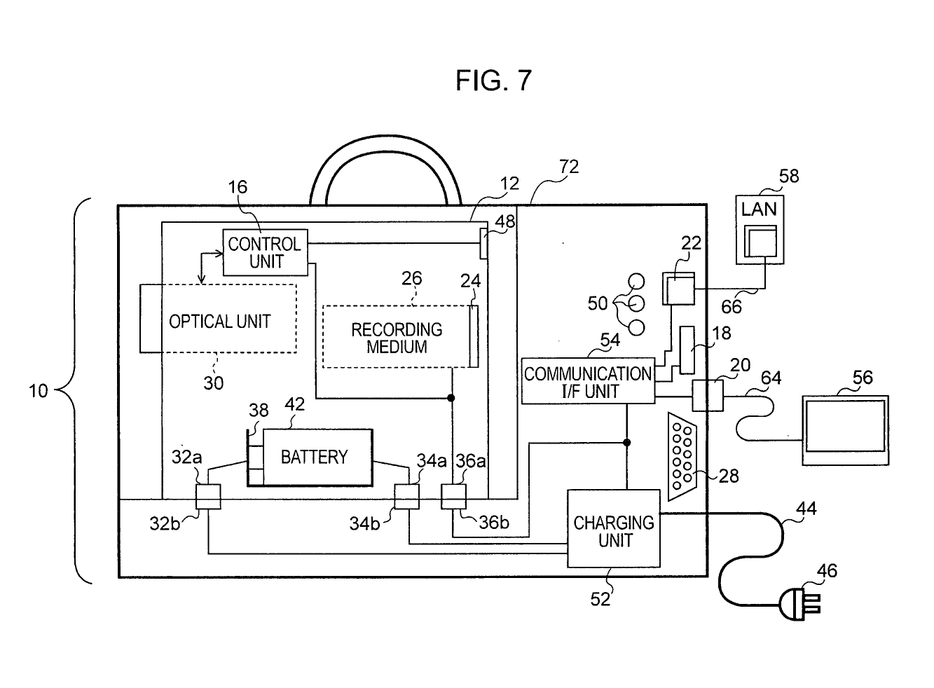

FIG. 7 is a schematic configuration block diagram of a projection apparatus according to a second exemplary embodiment of the present invention. The same components as those shown in FIG. 1 are denoted by the same reference numerals. The second exemplary embodiment is characterized in that a casing of a projection accessory section 14 is modified to the shape of a storage bag 72 (carry bag), so that a projection section 12 can be housed in the storage bag 72.

An example of the use of a projection apparatus according to the second exemplary embodiment will be described next. For example, when the user works outside for a sales activity, the user may need to perform a demonstration at a customer company. At that time, the user can bring the storage bag 72, in which the projection section 12 is housed, to the customer company. Before performing the demonstration, the user takes out the projection section 12 from the storage bag 72 to perform the demonstration. Even if the projection apparatus 10 is used among the personnel in the sales section, who often work outside, it does not take a long time to prepare for the demonstration. This reduces the time that customers, to whom the demonstration is to be performed, have to wait.

In the second exemplary embodiment, a configuration for reading out the data stored on a recording medium (e.g., memory card) 26 and projecting an image corresponding to the data is employed. In addition to this, a configuration for operating the projection apparatus 10 using a PC and directly inputting video signals or other equivalent data signals as known by one of ordinary skill in the relevant art to an optical unit 30 can be employed.

Other Modifications

As mentioned above, when establishing a LAN, a wireless LAN can be employed. A connection between a projection apparatus 10 and an external PC 56 can be made using a short-distance radio system, such as BLUETOOTH®. When establishing a wireless connection, a communication I/F unit 54 includes an interface compliant with the radio technologies.

Furthermore, the communication I/F unit 54 and external connectors (a USB connector 18, a USB connector 20, a LAN connector 22, a video signal input connector 28, an audio/video signal input connector 50) can be included in a projection section 12.

Moreover, although it is not shown in the figures, the following configuration is possible. A projection accessory section 14 includes a recording medium, such as a hard disk, and the projection section 12 communicates with the recording medium. Such configurations are also within the technical scope of exemplary embodiments of the present invention.

While the present invention has been described with reference to exemplary embodiments, it is to be understood that the invention is not limited to the discussed exemplary embodiments. The scope of the following claims is to be accorded the broadest interpretation so as to encompass all modifications, equivalent structures, and functions.

This application claims the benefit of Japanese Application No. 2005-112555 filed Apr. 8, 2005, which is hereby incorporated by reference herein in its entirety.

What is claimed is:

1. A projection apparatus comprising:
a projection section having a chargeable battery; and
a projection accessory section that is separable from the projection section,
wherein the projection section includes:
a recording medium capable of storing a data file;
a recording unit capable of recording the data file on the recording medium through a communication interface;
an image forming unit configured to read the data file recorded on the recording medium and forming a display image; and
an optical unit configured to project the image formed by the image forming unit, and wherein the projection accessory section includes:
a charging unit configured to charge the chargeable battery.

2. The projection apparatus according to claim 1, wherein the recording unit is capable of reading the data file recorded on the recording medium.

3. The projection apparatus according to claim 1, wherein the image forming unit forms an index image of the data file.

4. The projection apparatus according to claim 1, wherein the projection accessory section is a cradle for the projection section.

5. The projection apparatus according to claim 1, wherein the projection accessory section is a storage bag for housing the projection section.
